(19) United States
(12) Patent Application Publication
(10) Pub. No.: US 2004/0183458 A1
(43) Pub. Date: Sep. 23, 2004

(54) Uninterruptible led bulb string structure

(76) Inventor: Chun-Teng Lee, Hsin Chu City (TW)

Correspondence Address: Chun-Teng Lee, P.O BOX 7-288, TAIPEI, TW

(21) Appl. No.: 10/389,587

(22) Filed: Mar. 17, 2003

(51) Int. Cl. H05B 37/00

(52) U.S. Cl. 315/185 R; 315/185 S; 315/188

(57) ABSTRACT

The present invention relates to an uninterruptible LED bulb string structure, comprising a resistor coupled between two pins of a LED bulb, such that the two pins are wrapped by plastic materials to integrally fix the resistor to a front end position of a cathode connection line and an anode connection line of another pins of the chip, so that when the string of the LED bulbs is under the division of voltage or current or the electrically connected parts are disconnected, the resistor will connect the two isolated pins to continuously supply power to the entire LED bulb strings and keep a normal and reliable light source for the illumination. This invention specially helps the extension of its life and is not easy to scrape for the economic benefit.

### BACKGROUND OF THE INVENTION

1. Field of the Invention

The present invention relates to an uninterruptible LED bulb string structure, comprising a resistor coupled between two pins of a LED bulb, so that when the string of the LED bulbs is under the division of voltage or current or the electrically connected parts are disconnected.

2. Description of the Prior Art

There are various strings of light bulbs C6, C7, C9, etc. used for Christmas decorations. To cope with the market requirements, there is also water pipe lamp assembly. However, implanting a light bulb into a plastic pipe is a traditional assembly of latching two pins of the core pillar to a tungsten filament, and the interior of the light bulb must be vacuum so that there is no oxygen in the shell for the illumination. Since such production is very complicated and difficult, and the life of tungsten filament is quite limited, therefore it is not economically efficient for the material and labor costs. Now, we have the LED bulb as a substitute. Since the LED bulb has the power saving feature, it is a new product in the developing market. But the use of such light bulb string is restricted to its correct connection of the cathode and anode. If these cathode and anode connections are reverse, then the illumination chip will be damaged easily and the life of use will be shortened. Under long time of use, the connection line will be deteriorated and cause disconnection from time to time such that the entire string of LED bulbs in the connected water pipe is not lit anymore.

### SUMMARY OF THE INVENTION

The primary objective of the present invention is to provide an uninterruptible LED bulb string assembly, more particularly the one having a resistor connected between two pins of the LED bulb such that the plastic material of the pin integrally wraps and fixes a resistor onto the pin of a chip and the front position of the cathode and anode connection lines of another pin for its operation.

The secondary objective of the present invention is to provide an uninterruptible LED bulb string assembly, more particularly the one using a resistor to connect two isolated pins to obtain the uninterruptible power supply when the string of LED bulbs is under the situations of unstable division of voltage or current that causes the deterioration and disconnection between the connection lines, in order to keep the entire connected string of LED bulbs having a normal and stable light source for the illumination effect.

Another objective of the present invention is to provide an uninterruptible LED bulb string assembly, more particularly the one connecting two pins of the LED bulb to a resistor which is fixed onto the front position of the two cathode and anode connection lines for an uninterruptible power supply operation, so that the invention has the uninterruptible feature and helps extending the life of its use and thus not easy to scrape for better economic benefit.

### BRIEF DESCRIPTION OF THE DRAWINGS

FIG. 1 is an illustrative diagram of the uninterruptible LED bulb string connection according to the present invention;

FIG. 2 is an illustrative diagram of disassembled parts of the uninterruptible LED bulb string connection according to the present invention;

FIG. 3 is an illustrative diagram of the uninterruptible LED bulb string connection that connects a resistor for the uninterruptible power supply function according to the present invention;

FIG. 4 is a block diagram of the uninterruptible LED bulb string connection structure according to the present invention;

FIG. 5A and FIG. 5B are an illustrative diagram of the uninterruptible LED bulb string connection structure that connects another resistor outside the bulb according to the present invention.

### DETAILED DESCRIPTION OF THE PREFERRED EMBODIMENT

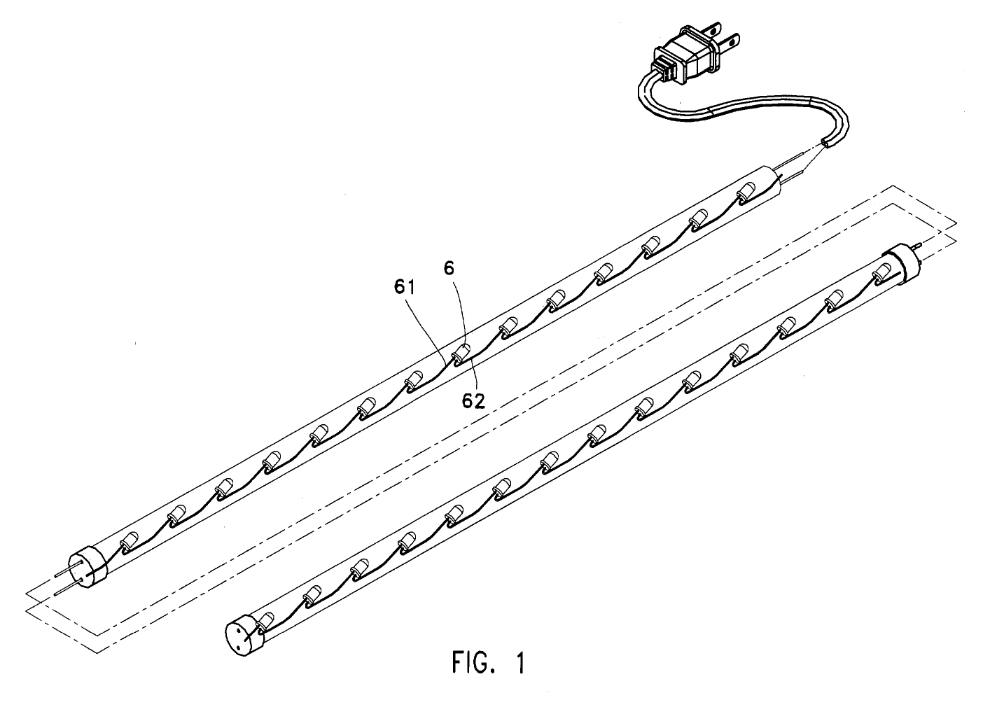

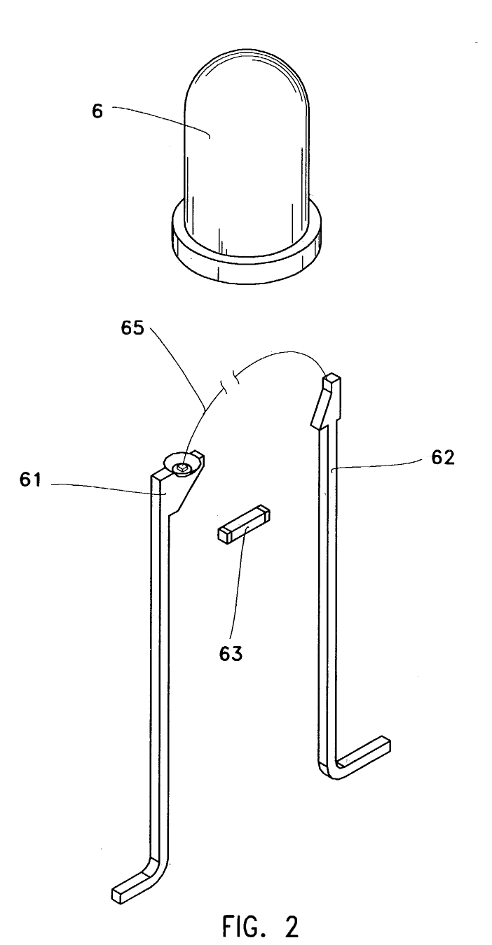

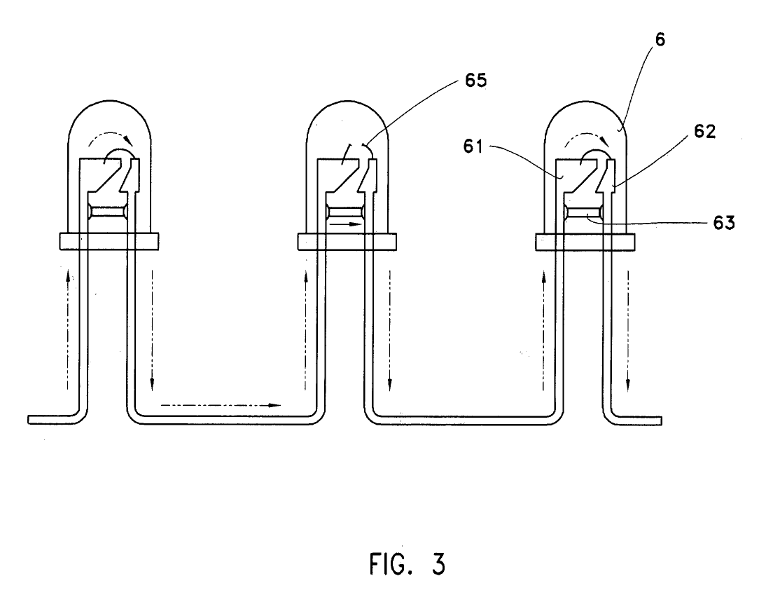

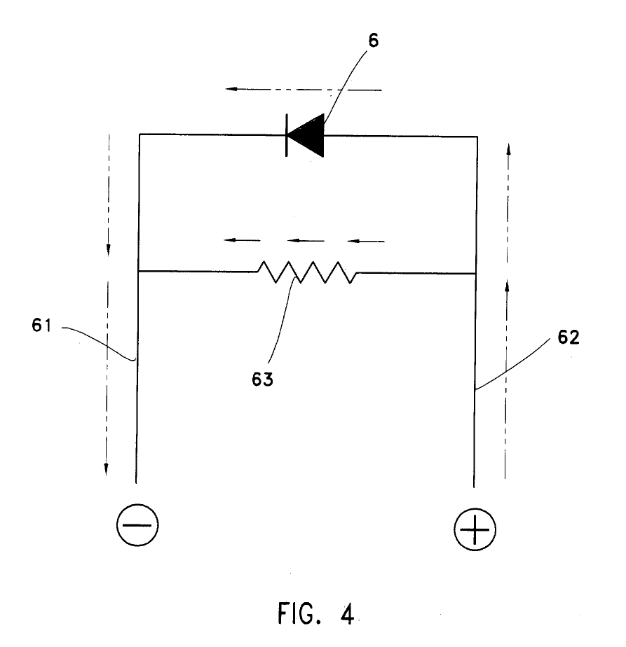

Please refer to FIGS. 1 to 4 for the diagrams of the uninterruptible LED bulb string assembly according to the present invention. The assembly of this invention comprises a LED bulb 6 having a resistor 63 soldered onto a position between a chip pin 61 and another pair of pins 62 before wrapping, so that the two pins are integrally wrapped and fixed into a position and the resistor is fixed into a position in the bulb, and disposed at the front end position of the pin of the illumination chip and the cathode and anode connection lines 65 of another isolated pins to constitute the uninterruptible and voltage supplementary conduction functions (see the block diagram in FIG. 4). If any LED bulb in the entire string of bulbs is under the situation of having unstable division of voltage or current, the chip will be damage easily, or the interconnected line 65 will be deteriorated and cause a power disconnection. Therefore, the resistor and its connection structure enable the two pairs of isolated pins to have an uninterruptible power supply, and keep a normal and stable light source for the illumination effects. This invention definitely can help extending the life of use of the entire string of bulbs, making the power supply uneasy to be interrupted, and is not easy to scrape for better economic benefit.

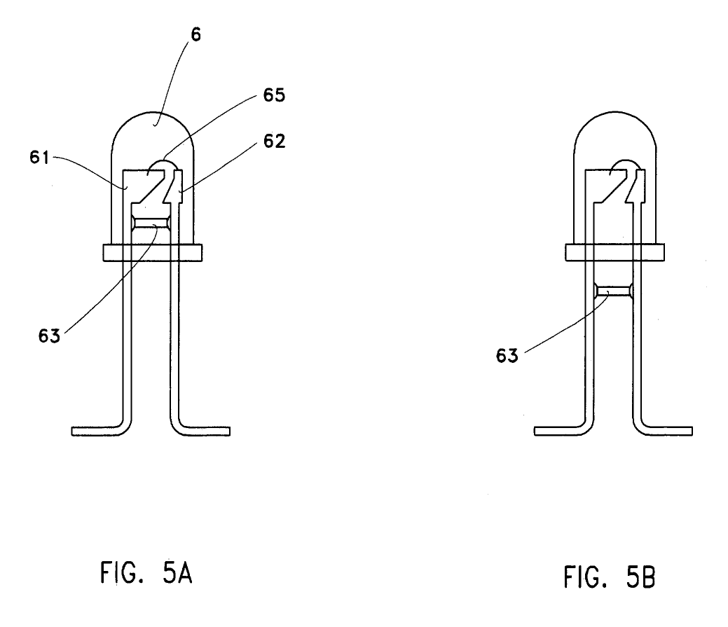

The resistor installed between the two pins in accordance to the present invention is not limited to fixing the components in positions by plastic wrapping in the interior according to the embodiment as shown in FIG. 5, but its soldered connection must be disposed at the front end position of the connection line of the two pins, so that the power supply of the entire string of LED bulbs can maximize its normal and stable current for the illumination effects.

While the invention has been described by means of specific embodiments, numerous modifications and variations could be made thereto by those skilled in the art without departing from the scope and spirit of the invention set forth in the claims.

What is claimed is:

1. An uninterruptible LED bulb string assembly, comprising a resistor electrically coupled between a pair of pins of a LED bulb chip and another pair of pins to integrally fix the two pins onto a front end position of a cathode connection line and an anode connection line, such that when said LED bulb being under the situation of division of voltage and current and the connection line being deteriorated to cause a power disconnection, the resistor connected to the two isolated pins obtaining an uninterruptible power supply and keeping a normal and stable light source for illumination effects.
